(19) United States
(12) Patent Application Publication
(10) Pub. No.: US 2009/0265328 A1
(43) Pub. Date: Oct. 22, 2009

(54) PREDICTING NEWSWORTHY QUERIES USING COMBINED ONLINE AND OFFLINE MODELS

(75) Inventors: Rajesh Parekh, Mountain View, CA (US); Jignashu Parikh, Bangalore (IN); Pavel Berkhin, Sunnyvale, CA (US)

Correspondence Address: Weaver Austin Villeneuve & Sampson - Yahoo!, P.O. BOX 70250, OAKLAND, CA, 94612-0250, US

(73) Assignee: Yahool Inc., Sunnyvale, CA (US)

(21) Appl. No.: 12/104,111

(22) Filed: Apr. 16, 2008

(51) Int. Cl. G06F 17/30

(52) U.S. Cl. 707/5; 707/3; 707/E17.108

(57) ABSTRACT

Methods and apparatus are described for identifying newsworthy search queries employing a machine learning approach which combines offline and online modeling to achieve a high level of accuracy as well as timeliness and scalability.

### BACKGROUND OF THE INVENTION

The present invention relates to the field of search technology and, in particular, to identifying search queries for which the inclusion of news results among the search results is appropriate.

Providers of search services and search engines on the Web are constantly trying to improve the relevancy of search results returned in response to user queries. At least part of these efforts relates to attempting to determine the type of result in which the user is interested. This is particularly important when the user is looking for information relating to current events. That is, search engines are increasingly being used as the starting point for virtually every type of information available on the Web, including currently breaking news stories. Thus, it is advantageous to determine whether a query is “newsworthy,” i.e., whether it was constructed with the intent of finding news articles. If that can be done successfully, then links to current and relevant news articles may be featured prominently among the search results, and the user's experience correspondingly enhanced.

Conventional techniques for identifying newsworthy queries have generally taken one of two basic approaches. One approach has relied on a human editorial staff to manually review breaking news, identify important news events, and then construct one or more potential queries for each news event for which news links relating to that news event would be prominently displayed. While this has proven very successful in terms of its accuracy, the limitations of such an approach with regard to timeliness and scalability are self-evident.

The other basic approach has relied on very simple automated techniques for matching queries to current news stories. Examples of this approach include matching a query to a news article if one or more words in the query appear in the text of the news article. This type of approach addresses the issue of timeliness and scalability, but is often inaccurate, resulting in the misidentification of particular queries as newsworthy, as well as irrelevant news stories being returned as results to otherwise newsworthy queries. That is, queries which are not the main concept of news articles can nevertheless match the articles. For example, the mention of email as a significant property of Yahoo! in a news article for Yahoo!'s quarterly results can match the query “email” even though it is unlikely that the query was directed to such a result. Alternatively, very generic queries can inadvertently match irrelevant articles. For example, the query “Yahoo” can show news results but it may not be the user intent to see news. Thus, this type of approach has the potential for negatively affecting user experience.

### SUMMARY OF THE INVENTION

According to the present invention, methods and apparatus are provided for identifying newsworthy search queries employing a machine learning approach which combines offline and online modeling.

According to various specific embodiments, incoming queries are determined to be newsworthy with reference to a first set of queries. The first set of queries was determined by a machine learning algorithm with reference to a first model which incorporates historical search query data and news index data. Where a first incoming query is determined to be newsworthy with reference to the first set of queries, one or more first news results are included among first search results generated in response to the first incoming query. Where a second incoming query is not determined to be newsworthy with reference to the first set of queries, whether the second incoming query relates to one or more recent news events not captured by the first model is determined with reference to a second model. The second model incorporates the news index data. Where the second incoming query is determined to relate to the one or more recent news events, one or more second news results are included among second search results generated in response to the second incoming query.

A further understanding of the nature and advantages of the present invention may be realized by reference to the remaining portions of the specification and the drawings.

### BRIEF DESCRIPTION OF THE DRAWINGS

FIG. 1 is a simple block diagram of a system for identifying newsworthy queries designed in accordance with a specific embodiment of the invention.

FIGS. 2-5 are flow diagrams illustrating an offline model for use with various embodiments of the invention.

FIG. 6 is a flow diagram illustrating an online model for use with various embodiments of the invention.

FIG. 7 is a flow diagram illustrating a technique for rewriting queries for use with specific embodiments of the invention.

FIG. 8 is a simplified diagram of a network environment in which specific embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention employ a machine learning approach to identifying newsworthy queries which combines some of the advantages associated with human editorial approaches and conventional automated techniques (i.e., accuracy combined with timeliness and scalability) while mitigating disadvantages associated with each. The invention employs a combination of offline models (i.e., automated computation not directly responsive to user queries, but computed at an earlier time) and online models (i.e., real-time computation in response to user queries) to achieve this.

Offline models suitable for use with embodiments of the invention are able to leverage multiple data sources to make very accurate predictions as to the newsworthiness of queries. In a particular implementation described herein, an offline model uses web search logs, news search logs, and a news index. The web search and news search logs provide user queries and associated user feedback in the form of their click behavior on returned search results. The news index provides detailed information about the articles that match the user queries, and meta-data about these articles such as the publisher, the publication time, the publication medium, the category of the news article, etc. These data sources are collectively leveraged to build a rich set of features for each user query. These features are in turn used to make “newsworthiness” predictions for the queries.

While offline models leverage rich information sources and make robust predictions regarding the “newsworthiness” of queries, they are inherently delayed as they rely on user feedback captured in log files which are typically aggregated, cleansed, and made available on a daily basis. This delay in getting relevant data can prevent an offline model from effectively detecting late breaking news events. Thus, “real-time” or online models may be used to complement offline models by focusing on the news index articles which are stored. As will be discussed, online models suitable for use with embodiments of the invention leverage spikes in matching news articles to determine the “newsworthiness” of queries.

Specific embodiments of the invention leverage critical velocity features in the modeling to enable more accurate predictions. Examples of such features include the ratio of the number of searches on a given day d to the number of searches on day d-1 (i.e., the previous day), and the ratio of the number of searches on day d to the number of searches on day d-7 (i.e., the same day last week). Such ratios may be used to decide whether a given search query is gaining or declining in popularity. In another example, the ratio of the click through rate (CTR) for a query in the News Search context to the CTR for a query in the Web Search context may be employed to provide key insight about the newsworthiness of a query.

Online models detect surges in matching news articles to make newsworthiness predictions. According to specific embodiments, such online models are constructed to deal with the issue of queries that are always in the news. For example, the query “facebook” is a very popular query and there tends to be occasional articles written about Facebook. However, in this case, care must be taken before designating “facebook” as a newsworthy query. That is, indicators from search logs, e.g., CTR for algorithmic search results, indicate that most users type “facebook” in order to navigate to Facebook.com. On the other hand, when Microsoft acquired a stake in Facebook there was a flurry of articles in a very short period of time; a period during which “facebook” was arguably a newsworthy query. This subtle change in the intent of the query can be captured by at least some of the online models employed by embodiments of the present invention.

According to specific embodiments, models employed by the invention provide newsworthiness predictions as continuous scores which can be efficiently leveraged to suitably blend news results together with algorithmic results. To continue the Facebook example, where such models have determined that the query “facebook” is more likely a navigational query and have assigned it a lower newsworthiness score, this lower score can be used to prevent presentation news results altogether, or simply to show them lower down on the search results page. Such an approach arguably provides a better user experience in that the navigational link to Facebook.com is at the top for most users who are looking for it, but for those who are looking for Facebook related news, the most recent news articles are displayed just below that, e.g., at the second or third position.

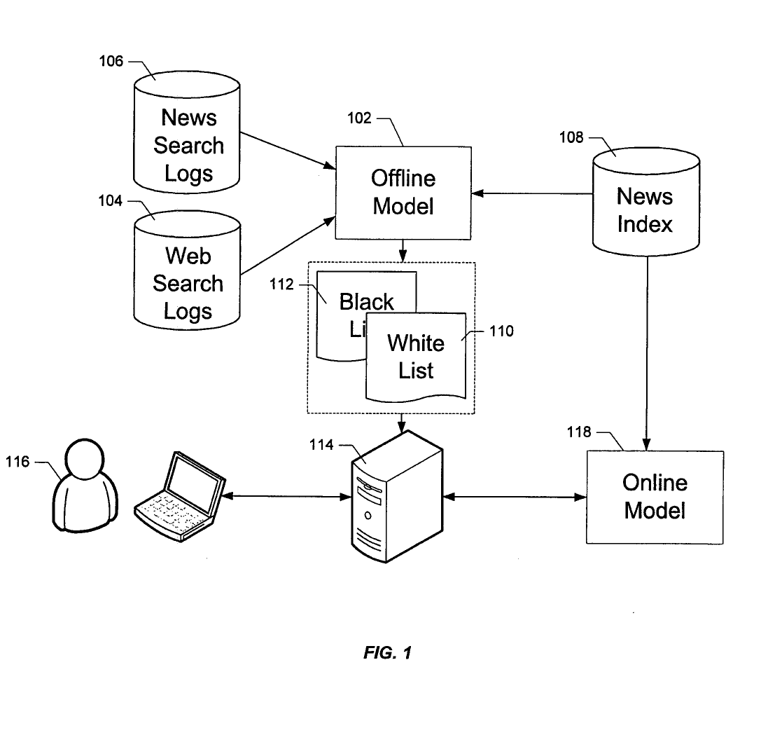

As mentioned above, offline models are characterized by some form of delay. Embodiments of the present invention take advantage of this in that their offline models are able to utilize a more rich and varied set of data sources, and more sophisticated and/or computationally expensive techniques than their online models to achieve a high degree of accuracy. On the other hand, the online models of such embodiments generally employ computationally light techniques with near-instantaneous response times to identify newsworthy queries which might otherwise be missed by the offline models. The various components and data sources associated with a particular embodiment of the invention are shown in FIG. 1.

An offline model 102 has access to a variety of data sources including web search logs 104 (e.g., Yahoo! Search at search.yahoo.com), news search logs 106 (e.g., Yahoo! News Search at news.yahoo.com), and a news index cataloging queries (or keywords) with matching news articles 108. Offline model 102 uses the data from these sources to generate a “white list” of newsworthy queries 110, as well as a “black list” 112 which either represents or includes queries which are not to be considered newsworthy. The white list of queries is then made available (e.g., on a web server 114) for comparison with incoming queries q generated by users 116. If an incoming query matches a query on the white list (and is not filtered by the black list), that query is considered newsworthy, and appropriate news-related results are presented in the search results page. Note that in some implementations, incoming queries are first checked against the black list, but other implementations need not be constrained in this manner.

As mentioned above, gradations of newsworthiness may be built into the models of the present invention to affect how news results are presented among search results. That is, for example, if a query is determined to be newsworthy, but scores relatively low for some features, this could affect the rank (i.e., the position) of the news results in the search results page. Alternatively, and as discussed above, where a newsworthy query also has a high likelihood that it is a navigational query, news results could be shown at a lower rank.

If, on the other hand, an incoming query is not matched to any of the queries on the white list, it is passed to online model 118 for further processing. Online model 118 typically utilizes fewer data sources than offline model 102; in this example, only news articles 108. The query is then matched to any news articles which are determined to relate to a completely new news event, or to a new development for an existing news event or thread. Links to any such articles are then presented in the search results page.

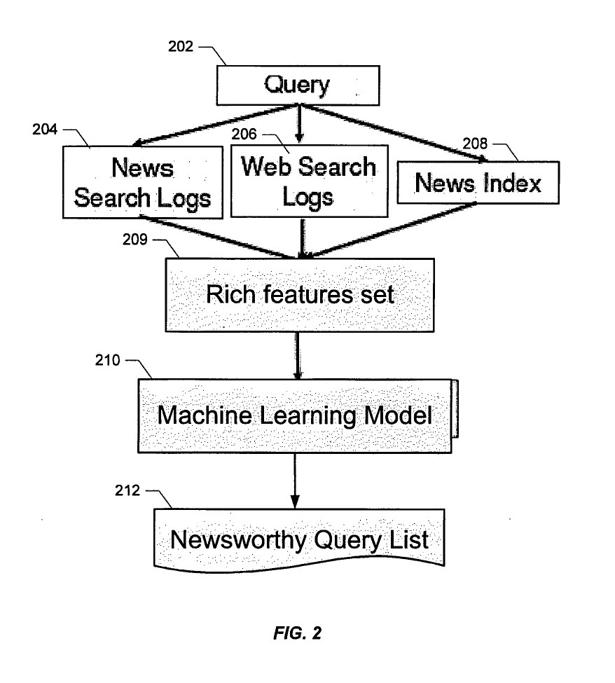

Development of an offline model of a system for identifying newsworthy queries according to a specific embodiment of the invention will now be described with reference to the flowcharts of FIGS. 2-5. Referring to FIG. 2, a set of queries 202, e.g., from Yahoo! query logs, is matched to news search logs 204, web search logs 206, and news index 208 to construct rich sets of features 209 to be used for scoring individual queries. The rich feature sets are then passed through a machine learning model 210 which generates newsworthy query list 212, i.e., the white list.

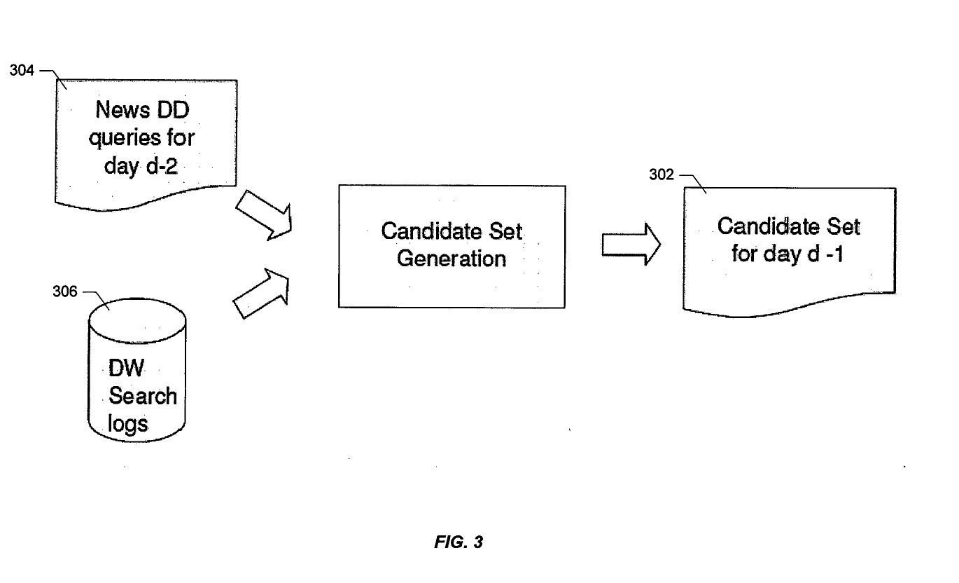

FIG. 3 illustrates more specific detail for identifying queries for inclusion in the white list for a given day d. It should be noted that, while the relevant time period in this example is one day, shorter or longer time period may be used without departing from the invention. A candidate set of queries for day d-1 (302) is generated with reference to white list queries for day d-2 (304) and queries from both news and web search logs for day d-1 (306). The reference to “day” as the relevant time period here is merely for illustrative purposes. It will be understood that other relevant time periods, e.g., hours, may be used. The candidate set generation can be viewed as a filtering procedure that identifies a subset of all queries which have some likelihood of being newsworthy, significantly reducing the volume of queries for feature computation.

According to a specific embodiment, filtering involves limiting the candidate set to high volume and high velocity queries. Volume may be determined, for example, using search frequency, and velocity by comparing the frequency of queries on day d with day d-1 and with day d-7. Filtering may also involve the use of search logs to determine if a query is a navigational query, commercial query, or pogo-stick query (defined below), as these types of queries are most likely to not be newsworthy.

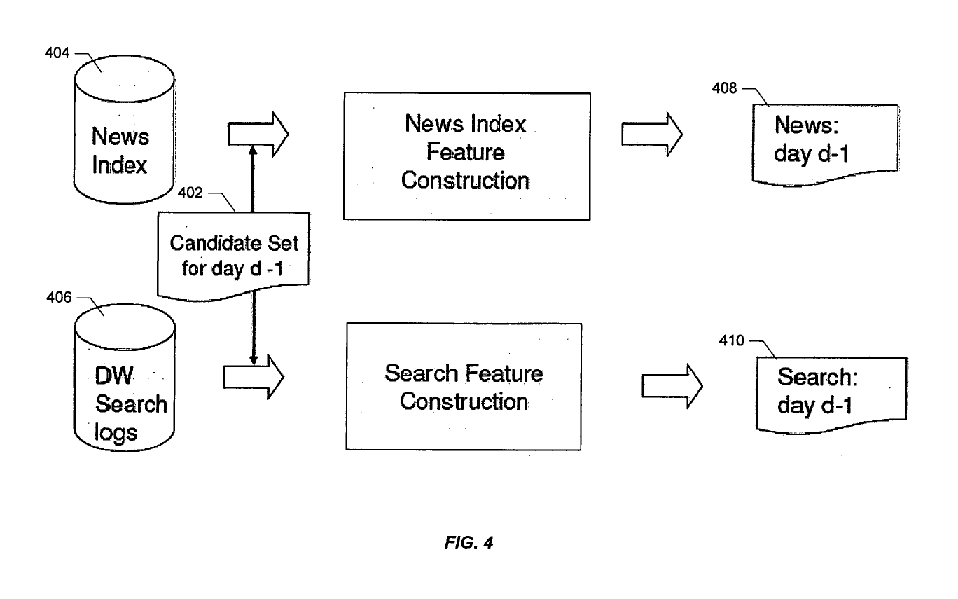

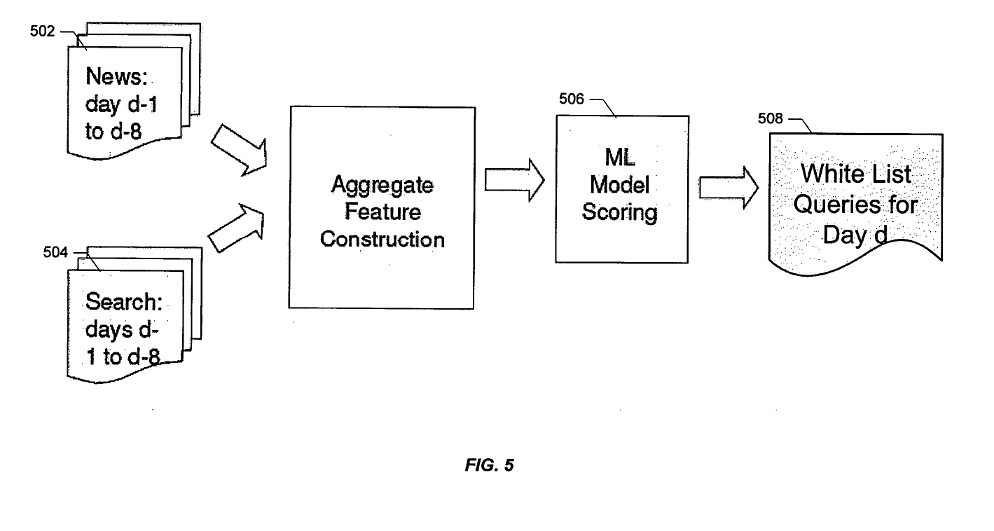

Referring now to FIG. 4, the candidate set of queries for day d-1 (402) is then matched against news index 404 and search logs 406 to construct rich feature sets, in this example, a news feature set for day d-1 (408), and a search feature set for day d-1 (410). As shown in FIG. 5, the news feature sets for days d-1 through d-8 (502) are then aggregated with the search feature sets for days d-1 through d-8 (504). The aggregated feature set is then provided to machine learning algorithm 506 to generate the white list queries for day d (508).

According to a specific class of embodiments, the click-through-rate (CTR) for news-related search results presented in response to newsworthy queries is used as a query feature in that it can be considered an objective measure of accuracy. The assumption is that, if a query has been correctly identified as a newsworthy query, there is a high likelihood that the user entering the query will select one or more of the new-related links which are prominently displayed among the search results. To train the machine learning model, the threshold value for CTR by which successful identification is measured can generally be set relatively high and is tunable for adaptation to particular applications.

As used herein the term “feature” refers to any of a wide range of attributes or characteristics of a query by which the newsworthiness of that query may be evaluated or scored. Such features might include, for example, number of words, number of matching articles, relevance score, query category (e.g., celebrity, local, shopping, etc.), commercial nature of query, search volume and/or CTR in different contexts (e.g., news search vs. web search), comparison of volume or CTRs in different contexts, CTR relative to different sections of the same page, publication date (i.e., recency), title and/or abstract match, source reputation, velocity (i.e., trends in features over time), etc. A wide range of other features suitable for particular applications may also be employed.

Any combination of these as well as other features may be employed. In addition, comparison of features in different contexts can be very effective in accurately predicting newsworthiness. For example, if a query is entered in a news search context, the same query in the more general web search context is more likely to also be newsworthy.

Aggregation of features over time allows the model to track changes in user interest, e.g., whether user interest in a particular topic is waxing or waning. This, in turn, allows the system to be very responsive, eliminating queries from the white list as, or even before they become stale. This is a distinct advantage over approaches which rely on human editorial resources in that, in addition to scalability issues discussed above, such approaches are only able to understand snapshots of user interest, and so often keep queries in the system for default periods of time which often exceed their relevance. It should be noted that the 8 day period described above is merely an example of a time period range which may be used. Implementations which employ shorter and longer periods are contemplated.

According to various embodiments, a variety of machine learning models may be employed in accordance with the invention including, for example, both linear techniques (e.g., Logistic Regression, Naïve Bayes, Support Vector Machines (SVM) (linear kernel), etc.), nonlinear techniques (e.g., Decision Trees and Rules, Stochastic Gradient Boosted Tree Methods, SVM (RBF kernel), etc.). Such techniques may be employed with both offline and online models.

Testing of the performance of an implementation of an offline model showed significant improvement in coverage, i.e., identification of more newsworthy queries, without sacrificing CTR. It also showed the benefits of the time-based or velocity aspects described above in that identification of particular queries as newsworthy more closely tracked the current importance of the corresponding news events as they waxed and waned.

However, offline models suitable for use with systems designed in accordance with the invention may also be characterized by a variety of challenges. For example, there are typically quite a few high frequency queries, many instances of which are navigational in nature, e.g., the names of major Web destinations. However, some instances of such terms may actually be newsworthy on a given day. Embodiments of the invention can deal with such a challenge by weighting or setting different limits for particular features, e.g., emphasizing or changing the threshold for the number of matching news articles.

In some cases, though, the problem of false positives, i.e., queries which are incorrectly identified as newsworthy, may be such that a more restrictive approach is required. In particular implementations, some queries are simply excluded from being treated as newsworthy (e.g., black list 112).

Another challenge relates to the possibility that the newsworthiness of a particular query might be sufficiently high for most days in a given range, but not high enough on some. This might then result in the query jumping on and off the white list. According to some embodiments, historical CTR data can be used to smooth out such effects.

To address at least some of the challenges associated with offline approaches to the identification of newsworthy queries, embodiments of the present invention also employ online approaches. According to one class of embodiments, and as described above, if an incoming query is not identified as newsworthy by an offline model, e.g., by matching a white list entry, the query is processed by an online model (e.g., online model 118) to determine whether there are a sufficient number of recent matching news articles to warrant treating this query as newsworthy. According to some embodiments, such online models are intended to capture late-breaking or recent news events which might not be picked up by offline models because of the inherent latency by which such models are characterized; even where the period employed by an offline model is relatively short, e.g., 4 hours.

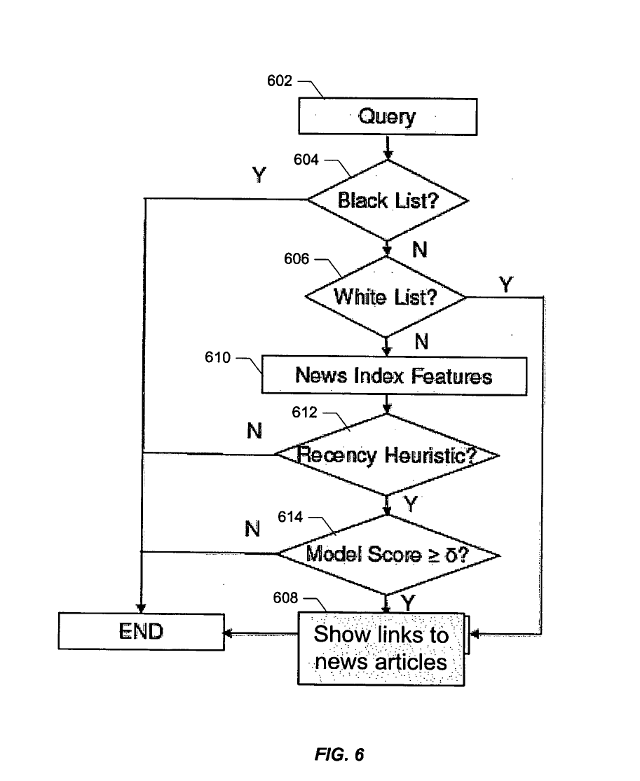

Incorporation of an online model to complement an offline model according to a specific implementation may be understood with reference to the flowchart of FIG. 6. In this example, an incoming query (602) is compared to or filtered by a black list (604). If the query matches a black list entry (or heuristic), the process ends with the query not being identified as newsworthy. Otherwise, the query is compared to white list of queries (606). If the query matches a white list entry, the query is identified as newsworthy, links to news stories are included among returned search results (608), and the process ends. As described above, the black and white lists are included in and developed by the offline model.

According to specific embodiments, the black list represents heuristics designed to capture various types of queries which should not be identified as newsworthy, e.g., highly navigational terms such as the names of major Web destinations, highly commercial terms (e.g., Hawaii vacation, car insurance, etc.), and so-called “pogo-stick” terms (e.g., cheap tickets, free games, etc.) which typically correspond to users who select many of the algorithmic search results in search of specific things. According to one embodiment, a query is identified as a navigational query if the CTR is very high (e.g., 75 or 80%) and the average rank for the selected search results links is less than 1.5, i.e., the selected links are always near the top of the first page of results. According to another embodiment, a query is identified as a pogo-stick query if the CTR is also very high (e.g., 75 or 80%) and the average rank for the selected search results links is greater than 10.5, i.e., the majority of selected links are on the second or subsequent pages of results.

Referring once again to FIG. 6, if the incoming query does not match either the black list or the white list, online features for the query are calculated and matching news articles are identified (610), e.g., from news index 108, and then subjected to a recency heuristic (612). According to a specific embodiment, only features needed to evaluate the recency heuristic are calculated at this point.

The recency heuristic is intended to ensure that the subject matter of the query is indeed currently relevant. That is, the white list is very effective in identifying newsworthy queries with the possible exception of those relating to the most current and late-breaking news events. Therefore, for any query not included in the white list to be considered newsworthy, it is important to have some level of confidence that there is breaking news. According to a specific embodiment, the recency heuristic only keeps queries for which some percentage (e.g., 40%) of the matching news articles were published in the most recent relevant time period after the white list was generated. Otherwise, the query is not considered newsworthy and the process ends.

If the query passes the recency heuristic, any additional needed features are calculated and, if the query scores sufficiently high according to an online model (614), links to news articles are presented among the search results (608). The feature set calculated for the online model is typically smaller than the feature set employed with the offline model, but may be overlapping. Given the real-time nature of the online model, an online feature set will not typically have access to the kind of information and/or the computing resources (especially time) that the offline model will generally have. According to some embodiments, a set of online features may include, for example, number of matching news articles, title match, abstract match, category match, publication date, relevance score, number of news sources, source reputation, etc.

According to some embodiments, at least some of the relevant features may be broken down into time periods in a manner similar to the one-day periods described above with reference to the offline model. Of course, in the case of the online model, the relevant time periods will typically be much shorter, e.g., hours, half-hours, etc. So, as with the offline model, the online model can take into account the manner in which the relevant features vary over time; the relevant time periods just being shorter and more recent. And as with the offline model, a wide variety of modeling techniques and scoring mechanisms may be employed with the online feature set to identify newsworthy queries.

As mentioned above, embodiments of the present invention may employ title match and abstract match to identify news articles matching a given query. Use of title match (i.e., all query terms in title) alone can be effective, but may result in otherwise newsworthy queries being ignored. On the other hand, including abstract or full text match can result in matching with irrelevant articles, and therefore improper identification of a query as newsworthy. An example will be instructive.

In 2007, the AFC Asian Cup, Asia's most prestigious soccer tournament, was hosted by Vietnam, Indonesia, Malaysia, and Thailand. During the relevant time period, a title match search for the query “asian cup” matched 254 articles. However, title match searches for “asian cup 2007,” “asian cup 07,” and “vietnam asian cup 2007” resulted in a total of zero matching articles, while “vietnam asian cup” matched only 23 articles. Thus, otherwise newsworthy queries did not score well for this particular feature. However, the number of false positives, e.g., “asian 2007,” resulting from loosening this requirement was also problematic.

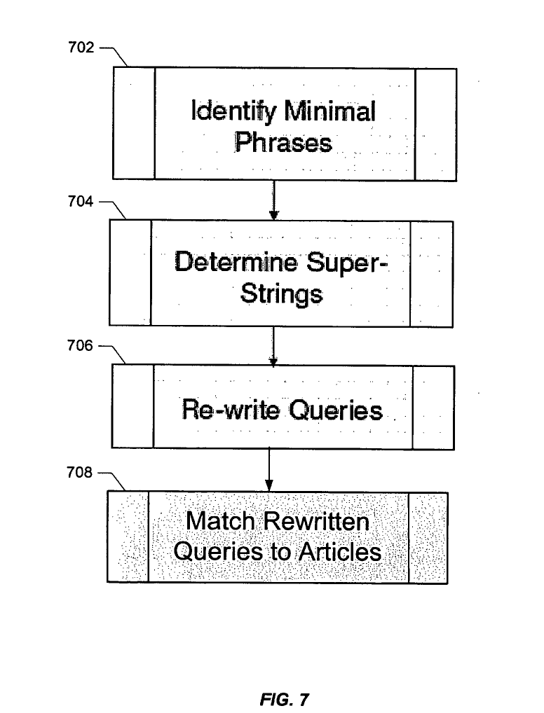

Therefore, according to a specific embodiment of the invention, an improved technique for identifying articles which match a query may be employed with embodiments of the invention. A general description of such a technique is described in U.S. Patent Application No. [unassigned] for [JMV TO INSERT TITLE FOR SUPERPHRASES APPLICATION] (Attorney Docket No. YAH1P143/Y04186US00), the entire disclosure of which is incorporated herein by reference for all purposes. Operation of a specific implementation of such a technique which may be employed with embodiments of the invention may be understood with reference to the flowchart of FIG. 7.

The basic problem of text-based search may be articulated in the following manner. Given a particular string of text, the objective is to find all objects which correspond to the concept(s) represented by the string of text. Common shortcomings of conventional approaches to the problem are the under-reporting and over-reporting of matches as described with reference to the “asian cup” example above.

According to a specific embodiment illustrated in FIG. 7, a set of original queries, e.g., as derived from web search logs 104 in FIG. 1, is processed to identify “minimal queries” each of which presumably corresponds to the main concept represented by some subset of the set of original queries (702). This is done by identifying all queries in the original set which cannot be reduced (i.e., by removing words) to obtain another one of the queries in the set. So, for example, if a set of queries corresponds to the various asian-cup-related queries described above, the query “asian cup” would be a minimal query in that no words can be removed from the query “asian cup” to obtain any of the other queries.

Once the minimal queries are identified, all queries in the original set which include each minimal query are identified as “super-strings” for that minimal query (704). For example, the queries “asian cup results” and asian cup 2007” would be identified as super-strings for the minimal query “asian cup.” It should be noted that exact matching of the minimal query may not necessarily be required, i.e., the words could be out of order and/or not consecutive.

Each of the super-string queries for a given minimal query are then rewritten to enhance the likelihood that objects, e.g., news articles in index 108 of FIG. 1, corresponding to the basic underlying concept represented by the minimal query are identified (706). This may be done in a variety of ways, but may be generally characterized as imposing different matching requirements on different parts of a given query.

Returning to our example of the minimal query “asian cup,” the super-string query “asian cup 2007” might be rewritten such that it could be represented in the following manner: title=asian; title=cup; title+abstract=2007. In other words, both of the strings “asian” and “cup,” i.e., the minimal query, must appear in the title of a matching article, while the string “2007” need only appear in either the title or the abstract. By keeping matching requirements tight for minimal queries, but loosening them for additional words not included in the minimal query, more articles may be identified (708) without sacrificing relevance.

And by improving coverage in this way, the newsworthiness of “super-string” queries corresponding to a particular minimal query may be more accurately determined. That is, by more effectively identifying news articles corresponding to a particular concept represented by a minimal query, the accuracy with which queries containing the minimal query may be classified is correspondingly enhanced. According to some embodiments, the rewritten super-string queries are added to the white list of queries if they are then found to satisfy the criteria for inclusion. According to other embodiments, the original queries corresponding to highly scored super-string queries may also or alternatively be included in the white list.

It should be noted that embodiments of the invention are contemplated in which enhancements represented by the technique illustrated in FIG. 7 are not employed. In addition, and as described in the patent application incorporated by reference above, the technique illustrated in FIG. 7 is merely an example of a particular application of a much more broadly applicable technique. For example, such a technique could be employed to identify clusters of related objects or documents in virtually any set of objects or documents.

The combination of offline and online models embodied by the present invention has resulted in scalable implementations which are both accurate and timely as evidenced by measured CTRs for news-related links included among search results which are nearly an order of magnitude better than CTRs for previous techniques.

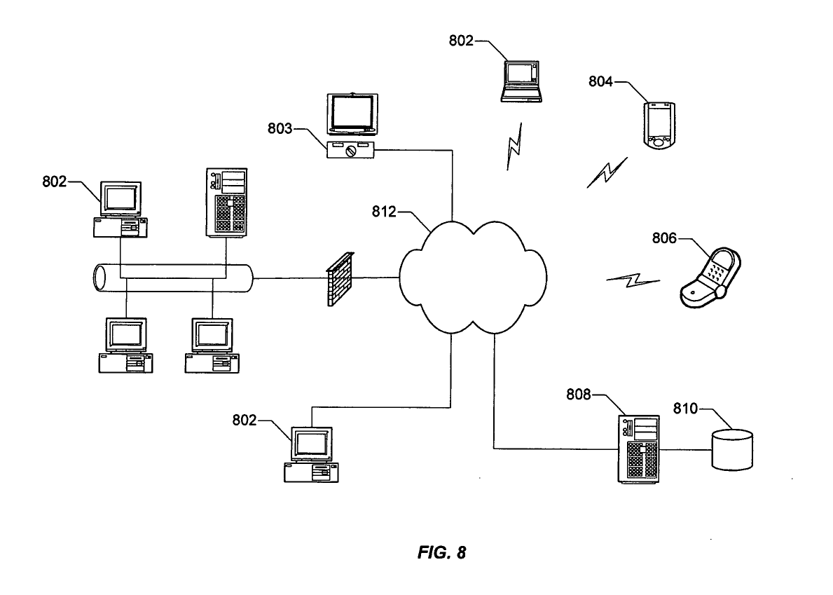

Embodiments of the present invention may be employed to facilitate identification of newsworthy queries and presentation of news results among search results in any of a wide variety of computing contexts. For example, as illustrated in FIG. 8, implementations are contemplated in which the relevant population of users interacts with a diverse network environment via any type of computer (e.g., desktop, laptop, tablet, etc.) 802, media computing platforms 803 (e.g., cable and satellite set top boxes and digital video recorders), handheld computing devices (e.g., PDAs, email clients, etc.) 804, cell phones 806, or any other type of computing or communication platform.

Once collected, the various data employed by embodiments of the invention may be processed in some centralized manner. This is represented in FIG. 8 by server 808 and data store 810 which, as will be understood, may correspond to multiple distributed devices and data stores. News results may then be provided to users in the network in response to newsworthy queries via the various channels with which the users interact with the network.

The various aspects of the invention may also be practiced in a wide variety of network environments (represented by network 812) including, for example, TCP/IP-based networks, telecommunications networks, wireless networks, etc. In addition, the computer program instructions and data structures with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for identifying newsworthy queries, comprising:
determining whether incoming queries are newsworthy with reference to a first set of queries, the first set of queries having been determined by a machine learning algorithm with reference to a first model which incorporates historical search query data and news index data;
where a first incoming query is determined to be newsworthy with reference to the first set of queries, including one or more first news results among first search results generated in response to the first incoming query;
where a second incoming query is not determined to be newsworthy with reference to the first set of queries, determining with reference to a second model whether the second incoming query relates to one or more recent news events not captured by the first model, the second model incorporating the news index data; and
where the second incoming query is determined to relate to the one or more recent news events, including one or more second news results among second search results generated in response to the second incoming query.

2. The method of claim 1 further comprising determining the first set of queries with the machine learning algorithm by representing each query in a superset of queries including the first set of queries with a plurality of features, and determining a newsworthiness score for each query in the superset with reference to the features.

3. The method of claim 2 wherein the plurality of features comprises one or more of number of words, number of matching articles, relevance score, query category, commercial nature, search volume in at least one search context, click-through-rate (CTR) in at least one search context, comparison of search volume multiple search contexts, comparison of CTR in multiple search contexts, comparison of CTR for different sections of a search results page, publication date, title match, abstract match, source reputation, or velocity features representing trends for the corresponding query over time.

4. The method of claim 1 further comprising facilitating presentation of the first news results and the first search results in first search results page in response to the first incoming query, the first news results being prominently placed among the first search results.

5. The method of claim 4 wherein placement of the first news results relative to the first search results is determined with reference to a newsworthiness measure for the first incoming query.

6. The method of claim 1 wherein including the first news results among the first search results only occurs where the first incoming query is not filtered with reference to one or more heuristics.

7. The method of claim 6 wherein the one or more heuristics comprises one or more of a first heuristic for identifying navigational queries, a second heuristic for identifying highly commercial queries, or a third heuristic for identifying pogo-stick queries.

8. The method of claim 1 wherein determining whether the second incoming query relates to one or more recent news events comprises representing the second incoming query with a plurality of features, and determining a newsworthiness score for the second incoming query with reference to the features.

9. The method of claim 8 wherein the plurality of features comprises one or more of number of matching news articles, title match, abstract match, category match, publication date, relevance score, number of news sources, or source reputation.

10. The method of claim 1 wherein determining whether the second incoming query relates to one or more recent news events comprises determining whether a percentage of news articles matching the second incoming query in a most recent time period exceeds a threshold percentage.

11. A computer program product for identifying newsworthy queries, the computer program product comprising at least one computer-readable medium having computer program instructions stored therein configured to enable at least one computing device to:
determine whether incoming queries are newsworthy with reference to a first set of queries, the first set of queries having been determined by a machine learning algorithm with reference to a first model which incorporates historical search query data and news index data;
include one or more first news results among first search results generated in response to a first incoming query where the first incoming query is determined to be newsworthy with reference to the first set of queries;
determine with reference to a second model whether a second incoming query relates to one or more recent news events not captured by the first model where the second incoming query is not determined to be newsworthy with reference to the first set of queries, the second model incorporating the news index data; and
include one or more second news results among second search results generated in response to the second incoming query where the second incoming query is determined to relate to the one or more recent news events.

12. The computer program product of claim 11 wherein the computer program instructions are configured to enable the at least one computing device to determine the first set of queries with the machine learning algorithm by representing each query in a superset of queries including the first set of queries with a plurality of features, and determining a newsworthiness score for each query in the superset with reference to the features.

13. The computer program product of claim 12 wherein the plurality of features comprises one or more of number of words, number of matching articles, relevance score, query category, commercial nature, search volume in at least one search context, click-through-rate (CTR) in at least one search context, comparison of search volume multiple search contexts, comparison of CTR in multiple search contexts, comparison of CTR for different sections of a search results page, publication date, title match, abstract match, source reputation, or velocity features representing trends for the corresponding query over time.

14. The computer program product of claim 11 wherein the computer program instructions are configured to enable the at least one computing device to facilitate presentation of the first news results and the first search results in first search results page in response to the first incoming query, the first news results being prominently placed among the first search results.

15. The computer program product of claim 14 wherein placement of the first news results relative to the first search results is determined with reference to a newsworthiness measure for the first incoming query.

16. The computer program product of claim 11 wherein the computer program instructions are configured to enable the at least one computing device to include the first news results among the first search results only where the first incoming query is not filtered with reference to one or more heuristics.

17. The computer program product of claim 16 wherein the one or more heuristics comprises one or more of a first heuristic for identifying navigational queries, a second heuristic for identifying highly commercial queries, or a third heuristic for identifying pogo-stick queries.

18. The computer program product of claim 11 wherein the computer program instructions are configured to enable the at least one computing device to determine whether the second incoming query relates to one or more recent news events by representing the second incoming query with a plurality of features, and determining a newsworthiness score for the second incoming query with reference to the features.

19. The computer program product of claim 18 wherein the plurality of features comprises one or more of number of matching news articles, title match, abstract match, category match, publication date, relevance score, number of news sources, or source reputation.

20. The computer program product of claim 11 wherein the computer program instructions are configured to enable the at least one computing device to determine whether the second incoming query relates to one or more recent news events by determining whether a percentage of news articles matching the second incoming query in a most recent time period exceeds a threshold percentage.

21. A system for identifying newsworthy queries, the system comprising at least one computing device configured to:
determine whether incoming queries are newsworthy with reference to a first set of queries, the first set of queries having been determined by a machine learning algorithm with reference to a first model which incorporates historical search query data and news index data;
include one or more first news results among first search results generated in response to a first incoming query where the first incoming query is determined to be newsworthy with reference to the first set of queries;
determine with reference to a second model whether a second incoming query relates to one or more recent news events not captured by the first model where the second incoming query is not determined to be newsworthy with reference to the first set of queries, the second model incorporating the news index data; and
include one or more second news results among second search results generated in response to the second incoming query where the second incoming query is determined to relate to the one or more recent news events.
